(19) United States
(12) Patent Application Publication
(10) Pub. No.: US 2018/0028283 A1
(43) Pub. Date: Feb. 1, 2018

(54) HEALING ABUTMENT ASSEMBLY, HEALING ABUTMENT AND SELECTING METHOD THEREOF

(71) Applicant: CHILIAD BIOMEDICAL TECHNOLOGY CO., LTD., Taichung City (TW)

(72) Inventors: Chun-Jung LIN, Taichung City (TW); Hsin-Yu LIU, Taichung City (TW)

(21) Appl. No.: 15/359,576

(22) Filed: Nov. 22, 2016

(30) Foreign Application Priority Data
Aug. 1, 2016 (TW) 105124330

(51) Int. Cl. A61C 8/00

(52) U.S. Cl. CPC A61C 8/008; A61C 8/0068; A61C 8/0089; A61C 8/0066; A61C 8/0016; A61C 8/0069

(57) ABSTRACT

A healing abutment assembly for disposing on an implant by an auxiliary tool includes a healing abutment and a connecting member. A body includes an accommodating space, a healing surrounding surface, a top surface and a bottom surface. The bottom surface is connected to the implant. The healing surrounding surface is connected between the top surface and the bottom surface. The accommodating space is communicated with the top surface and the bottom surface. An outline of the top surface is formed in a non-circular shape, and the healing surrounding surface is formed in a non-conical shape. A positioning structure is disposed on the top surface and removably connected to the auxiliary tool. The connecting member is removably connected to the body and the implant. The connecting member is passed through the body and disposed in the implant so as to fixedly connect the body to the implant.

### RELATED APPLICATIONS

This application claims priority to Taiwan Application Serial Number 105124330, filed Aug. 1, 2016, which is herein incorporated by reference.

### BACKGROUND

### Technical Field

The present disclosure relates to a healing abutment assembly, a healing abutment and a selecting method thereof. More particularly, the healing abutment assembly, the healing abutment and the selecting method thereof have special positioning structures and are controlled by an auxiliary tool.

### Description of Related Art

A dental implant surgery provides various methods and apparatus for compensating for the loss of natural teeth. Dental implants are devices that are designed to be screwed into the human jawbone and serve as a mounting for a prosthetic in the shape and color of the tooth it is replacing. The primary advantage of implants over bridgework and partial dentures is that the installation is of a permanent nature and does not require the care, maintenance, comfort problems or adjustment associated with bridgework and dentures.

One conventional method is a single-stage dental restoration. The natural tooth can be replaced with a prosthetic tooth that is mounted on a unibody implant or a separate abutment secured to an implant. In the instance utilizing a separate implant and abutment, the implant is first installed in the patient's jawbone, typically through threaded engagement. A separate abutment is then secured to the coronal end of the implant and, after sufficient osseointegration of the implant with the patient's jawbone, the prosthetic tooth is secured to the abutment. In the single-stage dental restoration, the implant is installed into the patient's jaw bone and allowed sufficient time to osseointegrate. After a period of time, the prosthetic tooth is installed on the coronal end of the unibody implant. However, this conventional single-stage dental restoration easily causes wound infection around the abutment and the gums damage, thus increasing the patient's pain and discomfort.

Another conventional method is a two-stage dental restoration having a first stage and a second stage. In the first stage, a dental implant in inserted in the jawbone of a dental patient in the location of the natural root of the lost tooth. After the first stage surgery, the implant is left in position in the jawbone, covered by the patient's fleshy gum tissue, for several months until it becomes osseointegrated within the patient's jawbone. Thereafter, in the second stage, the gum tissue is opened to expose an end of the implant, and a healing abutment is attached to the implant until the surrounding gum tissue heals around the abutment. After the gum tissue has healed, the healing abutment is typically removed and the implant is available to support an artificial tooth. In general, the healing abutment is made of titanium and has a conical shape. However, the cost of this conventional healing abutment is too thigh to implement, and the structure of the conventional healing abutment formed in a conical shape may cause great gums damage during the removing procedure because of the rotation between the conventional healing abutment and the gums, thereby increasing the wound area. Therefore, a healing abutment assembly, a healing abutment and a selecting method thereof having the features of low cost, convenient operation and fitting teeth shapes are commercially desirable.

### SUMMARY

According to one aspect of the present disclosure, a healing abutment for disposing on an implant by an auxiliary tool includes a body and a positioning structure. The body includes an accommodating space, a healing surrounding surface, a top surface and a bottom surface. The bottom surface is connected to the implant. The healing surrounding surface is connected between the top surface and the bottom surface. The accommodating space is communicated with the top surface and the bottom surface, and the healing surrounding surface is formed in a non-conical shape. The positioning structure is disposed on the top surface and removably connected to the auxiliary tool.

According to another aspect of the present disclosure, a healing abutment assembly for disposing on an implant by an auxiliary tool includes a healing abutment and a connecting member. The healing abutment includes a body and a positioning structure. The body includes an accommodating space, a healing surrounding surface, a top surface and a bottom surface. The bottom surface is connected to the implant. The healing surrounding surface is connected between the top surface and the bottom surface. The accommodating space is communicated with the top surface and the bottom surface. An outline of the top surface is formed in a non-circular shape, and the healing surrounding surface is formed in a non-conical shape. The positioning structure is disposed on the top surface and removably connected to the auxiliary tool. The connecting member is removably connected to the body and the implant. The connecting member is passed through the body and disposed in the implant so as to fixedly connect the body to the implant.

According to further another aspect of the present disclosure, a selecting method of a healing abutment provides a position judging step and a healing abutment selecting step. The position judging step is for judging a teeth position corresponding to an implant. The healing abutment selecting step is for selecting the healing abutment including a healing surrounding surface and a positioning structure. The healing surrounding surface is formed in a non-conical shape, and the healing abutment is corresponding to the teeth position.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a healing abutment assembly disposed on an implant according to one embodiment of the present disclosure;

FIG. 2 shows an exploded view of the healing abutment assembly of FIG. 1;

FIG. 3 shows a cross-sectional view of the healing abutment assembly of FIG. 2;

FIG. 4 shows a cross-sectional view of the healing abutment assembly of FIG. 1;

FIG. 5 shows a schematic view of a healing abutment and an auxiliary tool corresponding to the healing abutment of FIG. 1;

FIG. 6 shows a schematic view of a plurality of healing abutments corresponding to a plurality of teeth positions according to one embodiment of the present disclosure;

FIG. 7A shows a schematic view of a healing abutment according to another embodiment of the present disclosure;

FIG. 7B shows a schematic view of a healing abutment according to further another embodiment of the present disclosure;

FIG. 8A shows a schematic view of a healing abutment according to still further another embodiment of the present disclosure;

FIG. 8B shows a schematic view of the healing abutment and an auxiliary tool corresponding to the healing abutment of FIG. 8A;

FIG. 9 shows a flow chart of a selecting method of a healing abutment according to one embodiment of the present disclosure; and

FIG. 10 shows a flow chart of an operating method applied in a healing abutment assembly according to one embodiment of the present disclosure.

### DETAILED DESCRIPTION

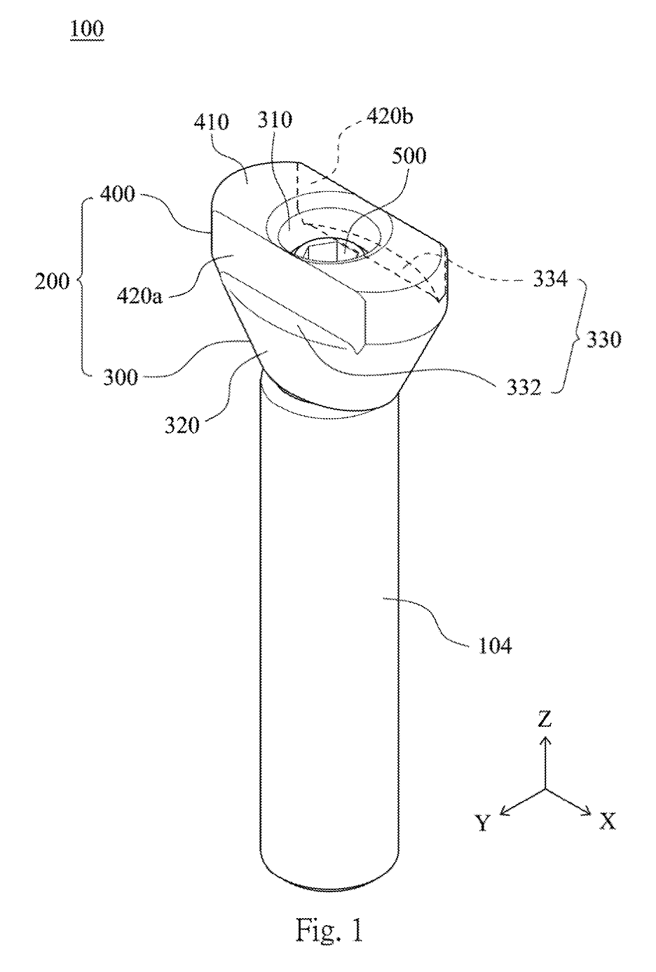

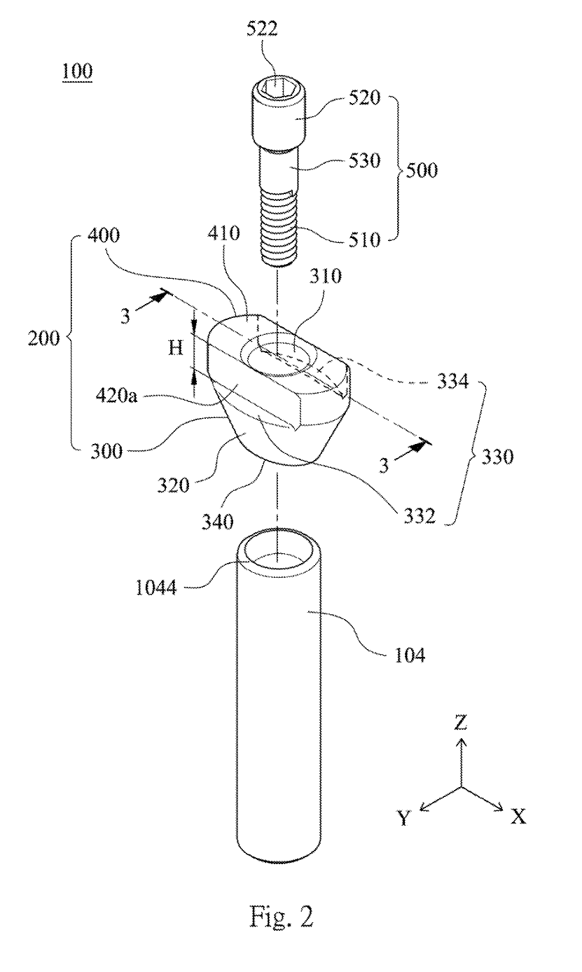

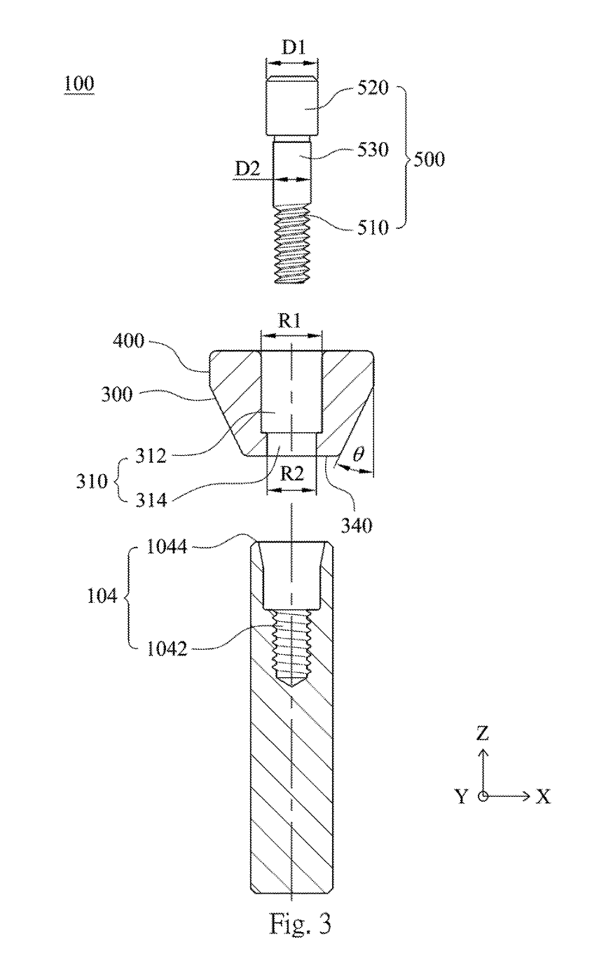

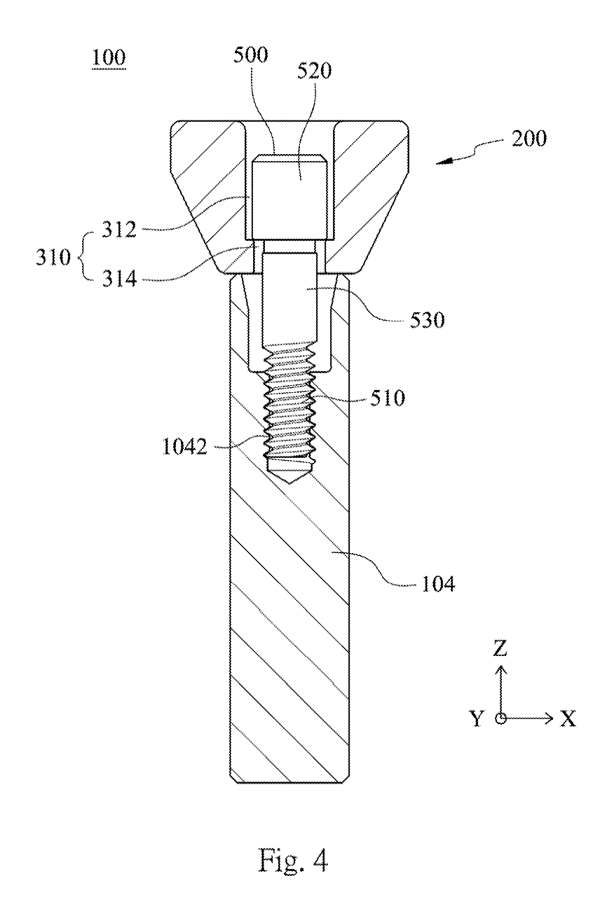

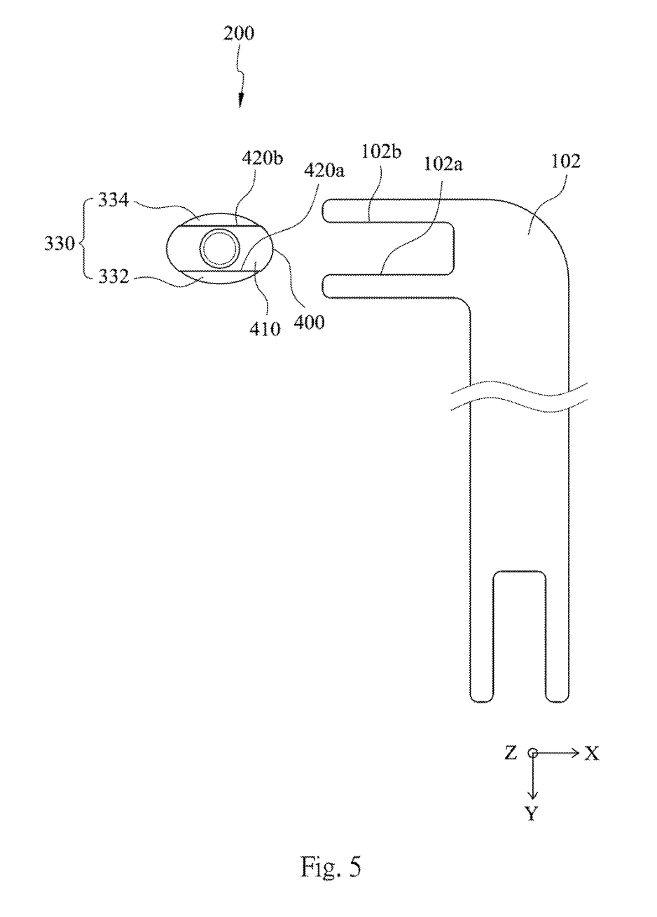

FIG. 1 shows a schematic view of a healing abutment assembly 100 disposed on an implant 104 according to one embodiment of the present disclosure; FIG. 2 shows an exploded view of the healing abutment assembly 100 of FIG. 1; FIG. 3 shows a cross-sectional view of the healing abutment assembly 100 of FIG. 2; FIG. 4 shows a cross-sectional view of the healing abutment assembly 100 of FIG. 1; and FIG. 5 shows a schematic view of a healing abutment 200 and an auxiliary tool 102 corresponding to the healing abutment 200 of FIG. 1. In FIGS. 1-5, the healing abutment assembly 100 for disposing on the implant 104 by the auxiliary tool 102 includes the healing abutment 200 and a connecting member 500.

The healing abutment 200 includes a body 300 and a positioning structure 400. The body 300 includes an accommodating space 310, a healing surrounding surface 320, a top surface 330 and a bottom surface 340. The accommodating space 310 is communicated with the top surface 330 and the bottom surface 340. An extending direction of the accommodating space 310 is parallel to a Z-axis direction. The accommodating space 310 has a first space 312 and a second space 314. The first space 312 is communicated with the second space 314. The first space 312 has a cylindrical shape and a first inner diameter R1. The second space 314 has the cylindrical shape and a second inner diameter R2, and the first inner diameter R1 is greater than the second inner diameter R2. In addition, the healing surrounding surface 320 is formed in a non-conical shape. The healing surrounding surface 320 is connected between the top surface 330 and the bottom surface 340. There is an angle θ between an extending direction of the healing surrounding surface 320 and the Z-axis direction, so that the healing surrounding surface 320 is formed in an inverted cone-shaped configuration and has a wide top and a narrow bottom. The top surface 330 and the bottom surface 340 are parallel to an X-Y plane. An outline area of the top surface 330 is greater than an outline area of the bottom surface 340. The outline of the top surface 330 is formed in a non-circular shape. The top surface 330 includes a first surface region 332 and a second surface region 334. The first surface region 332 is symmetric with the second surface region 334 along an X-axis direction. The bottom surface 340 is connected to the implant 104.

The positioning structure 400 is disposed on the top surface 330 and removably connected to the auxiliary tool 102. In detail, the positioning structure 400 is disposed on the body 300 and is connected to the top surface 330. The shape of the positioning structure 400 is corresponding to the shape of the auxiliary tool 102, thus positioning and rotating the body 300 via the auxiliary tool 102. The positioning structure 400 includes a third surface region 410 and two movable abutting surfaces 420a, 420b. The third surface region 410 is located between the first surface region 332 and the second surface region 334. There is a first height difference H between the third surface region 410 and the first surface region 332. There is a second height difference between the third surface region 410 and the second surface region 334, and the first height difference H is equal to the second height difference. The third surface region 410 is higher than the first surface region 332 and the second surface region 334. The two movable abutting surfaces 420a, 420b are opposite to each other and parallel to the Z-axis direction. The movable abutting surface 420a is connected between the first surface region 332 and the third surface region 410. The movable abutting surface 420b is connected between the second surface region 334 and the third surface region 410. The body 300 and the positioning structure 400 are both made of plastic material and integrally connected with each other. The healing abutment 200 has a flesh color or a white color, and the color of the healing abutment 200 is similar with the surrounding gums or adjacent teeth thereof, thereby pleasing to the eye of an observer and allowing a physician to quickly identify the status of other teeth. In FIGS. 1-5, the healing abutment 200 has a flesh color, and the positioning structure 400 is a convex portion. The auxiliary tool 102 includes two auxiliary abutting surfaces 102a, 102b. When the healing abutment 200 is engaged by the auxiliary tool 102, the two auxiliary abutting surfaces 102a, 102b are connected to the two corresponding movable abutting surfaces 420a, 420b, respectively. The auxiliary tool 102 can be rotated by the physician in the X-Y plane, thus rotating the healing abutment 200. When the connecting member 500 is rotated, the positioning structure 400 of the healing abutment 200 cooperated with the auxiliary tool 102 can prevent the healing abutment 200 from rotating relative to the implant 104, thereby increasing the stability and convenience of installing or removing the healing abutment 200. Moreover, the healing abutment 200 is a temporary device in a dental implant surgery procedure. After the implant 104 engaged into the bone of the mouth (the patient's jawbone), the healing abutment 200 will be removed, and then an abutment and a crown are disposed on the implant 104 to accomplish the dental implant surgery. The healing abutment 200 of the present disclosure is made of plastic material and has the healing surrounding surface 320 formed in a non-conical shape, thereby greatly reducing the gums damage during a removing procedure of the healing abutment 200 and being a great help for patients.

The connecting member 500 is removably connected to the body 300 and the implant 104. The connecting member 500 is passed through the body 300 and disposed in the implant 104 so as to fixedly connect the body 300 to the implant 104. In detail, the connecting member 500 includes a threaded portion 510, an abutting portion 520 and a connecting portion 530. The implant 104 has a threaded hole 1042 and an end surface 1044. The threaded portion 510 of the connecting member 500 is disposed through the accommodating space 310 of the healing abutment 200 and is screwed into the threaded hole 1042 of the implant 104 so as to tightly connect the end surface 1044 to the bottom surface 340 of the body 300. In addition, the abutting portion 520 has a first diameter D1 and is corresponding to the first space 312. The first diameter D1 is smaller than the first inner diameter R1. The connecting portion 530 is connected between the threaded portion 510 and the abutting portion 520. The connecting portion 530 has a second diameter D2 and is corresponding to the second space 314. The second inner diameter R2 is greater than or equal to the second diameter D2 and smaller than the first diameter D1. Therefore, the threaded portion 510 of the connecting member 500 can be smoothly passed through the first space 312 and the second space 314 sequentially and screwed into the threaded hole 1042 of the implant 104. The abutting portion 520 can be rotated by a rotary tool (not shown), thereby moving the abutting portion 520 downwardly via the threaded portion 510, i.e. the abutting portion 520 moved in a negative Z-axis direction. When the threaded portion 510 is screwed into the threaded hole 1042, a bottom edge of the abutting portion 520 is tightly connected to a junction between the first space 312 and the second space 314, thus tightly connecting the end surface 1044 of the implant 104 to the bottom surface 340 of the body 300. The rotary tool (not shown) is corresponding to a hexagonal hole of the abutting portion 520. Furthermore, when the healing abutment 200 is removed, the physician may firstly use the auxiliary tool 102 to position the positioning structure 400 of the healing abutment 200, and then use the rotary tool to remove the connecting member 500. Finally, the physician moves the healing abutment 200 upwardly, i.e. the healing abutment 200 moved in a positive Z-axis direction, thereby separating the healing surrounding surface 320 from the gums. Accordingly, the structure of the present disclosure can effectively prevent the healing surrounding surface 320 from rotating relative to the gums under condition of the healing abutment 200 having the positioning structure 400 and the healing surrounding surface 320 formed in the non-conical shape, thus greatly reducing the gums damage during the removing procedure of the healing abutment 200. On the contrary, the structure of the conventional healing abutment formed in a conical shape may cause great gums damage during the removing procedure because of the rotation between the conventional healing abutment and the gums, thereby increasing the wound area. Thus, the structure of the healing abutment 200 of the present disclosure can be a great help for patients.

The healing abutment 200 of the present disclosure can be made of medical grade plastics, medical grade titanium, titanium alloy, glass-ceramic materials, feldspar, zirconia, noble metal or non-noble metal. In detail, the medical grade plastic is polymethyl methacrylate (PMMA) or polyetheretherketone (PEEK). The noble metal is a high gold alloy (which contains 70% of gold, palladium and platinum), a low gold alloy (which contains 45-60% of gold, palladium and platinum), a palladium-silver alloy or a metal-ceramic alloy. The non-noble metal is a cobalt-chromium alloy, a cobalt-chromium-nickel alloy or a chromium-nickel alloy. The material of the healing abutment 200 can be determined by a manufacturer according to the requirements of the particular application.

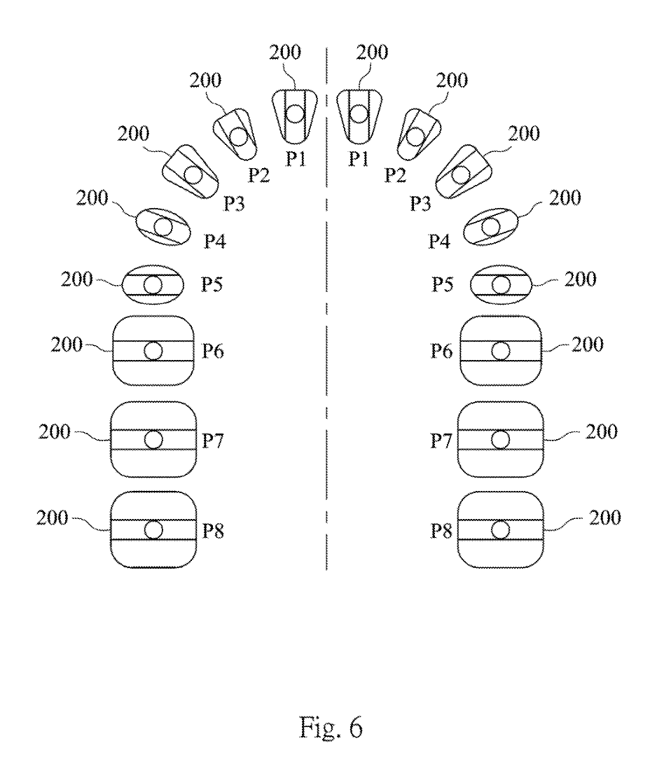

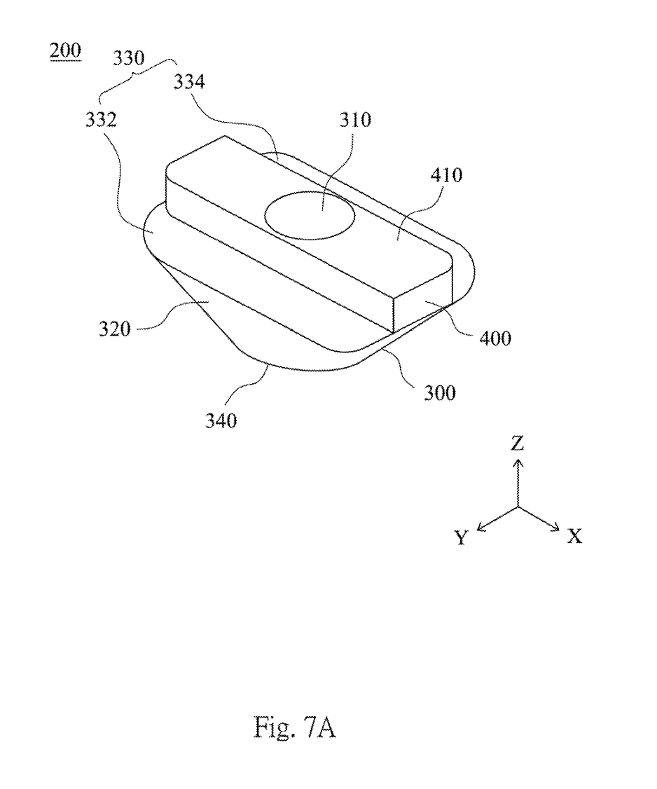

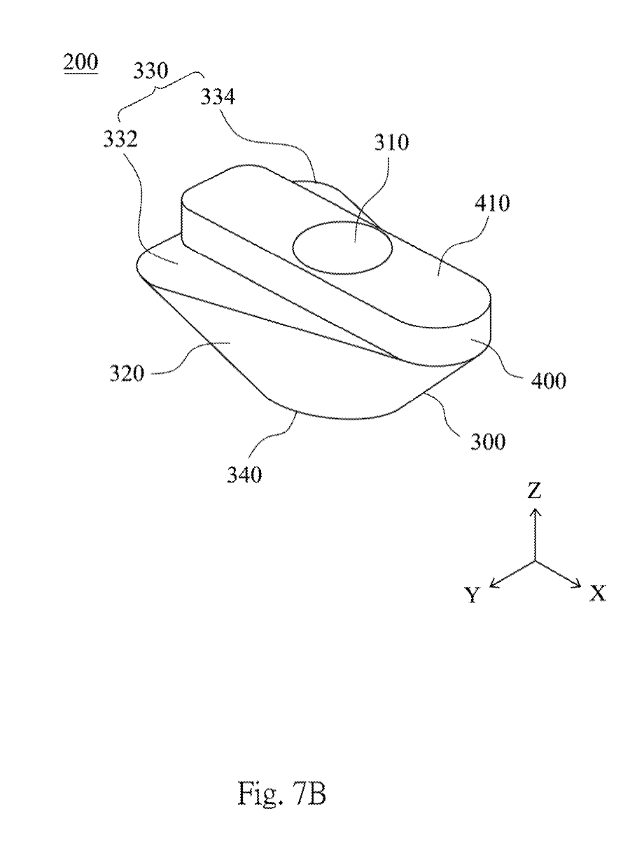

FIG. 6 shows a schematic view of a plurality of healing abutments 200 corresponding to a plurality of teeth positions according to one embodiment of the present disclosure; FIG. 7A shows a schematic view of a healing abutment 200 according to another embodiment of the present disclosure; and FIG. 7B shows a schematic view of a healing abutment 200 according to further another embodiment of the present disclosure. In FIG. 6, the installation of the specific healing abutments 200 of the present disclosure on the different teeth positions can be successfully performed for gums healing, crowns installation and fitting teeth shapes. In general, the teeth positions of a person are arranged from outside to inside in order of a central incisor P1, a lateral incisor P2, a canine P3, a first premolar P4, a second premolar P5, a first molar P6, a second molar P7 and a third molar P8. In FIG. 6, the healing surrounding surface 320 of each healing abutment 200 has one of three shapes which represent a triangular cone shape, an elliptical cone shape and a quadrangular cone shape, respectively. The top surface 330 of the body 300 of each healing abutment 200 has one of three shapes which represent a rounded triangular shape, an elliptical shape and a rounded quadrangular shape, respectively. The healing surrounding surface 320 is formed in the triangular cone shape, and the top surface 330 is formed in the rounded triangular shape corresponding to the teeth position of the central incisor P1, the lateral incisor P2 or the canine P3, as shown in FIG. 7B. The healing surrounding surface 320 is formed in the elliptical cone shape, and the top surface 330 is formed in the elliptical shape corresponding to the teeth position of the first premolar P4 or the second premolar P5, as shown in FIG. 2. The healing surrounding surface 320 is formed in the quadrangular cone shape, and the top surface 330 is formed in the rounded quadrangular shape corresponding to the teeth position of the first molar P6, the second molar P7 or the third molar P8, as shown in FIG. 7A. In general, the central incisor P1 of an adult human is greater than the lateral incisor P2, thereby manufacturing the healing abutments 200 with different shapes and sizes to meet the requirements of a variety of teeth positions.

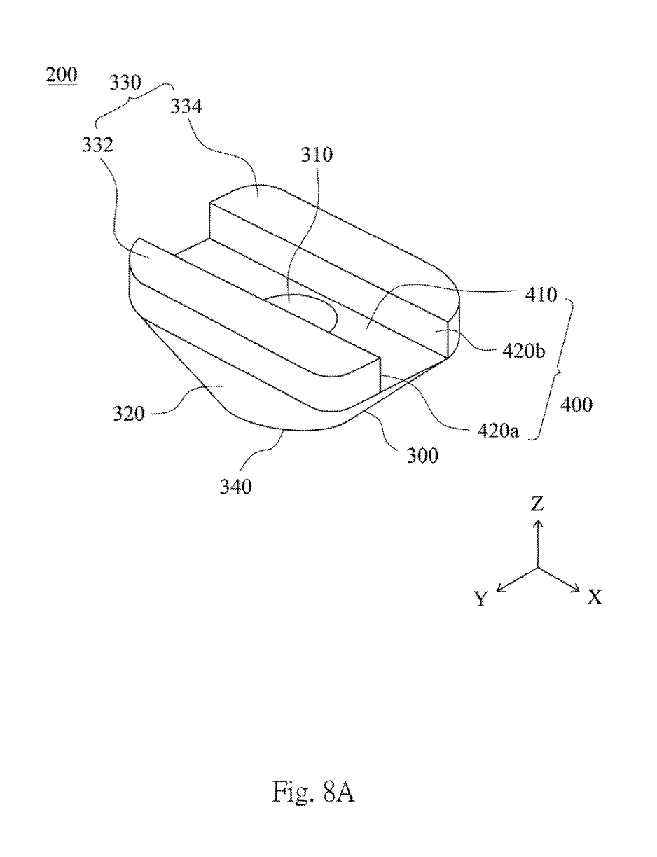

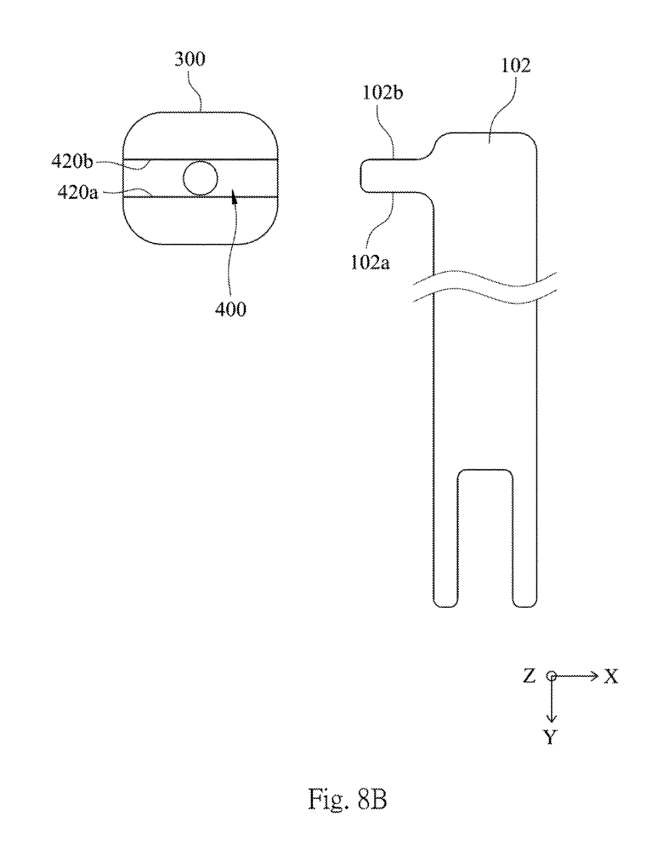

FIG. 8A shows a schematic view of a healing abutment 200 according to still further another embodiment of the present disclosure; and FIG. 8B shows a schematic view of the healing abutment 200 and an auxiliary tool 102 corresponding to the healing abutment 200 of FIG. 8A. The healing abutment 200 includes a body 300 and a positioning structure 400. The body 300 includes an accommodating space 310, a healing surrounding surface 320, a top surface 330 and a bottom surface 340. The top surface 330 includes a first surface region 332 and a second surface region 334. The positioning structure 400 is a concave groove. The positioning structure 400 includes a third surface region 410 and two movable abutting surfaces 420a, 420b. The third surface region 410 is located between the first surface region 332 and the second surface region 334. There is a first height difference between the third surface region 410 and the first surface region 332. There is a second height difference between the third surface region 410 and the second surface region 334, and the first height difference is equal to the second height difference. The third surface region 410 is lower than the first surface region 332 and the second surface region 334 so as to form the concave groove by the two movable abutting surfaces 420a, 420b and the third surface region 410. The two movable abutting surfaces 420a, 420b are opposite to each other and parallel to the Z-axis direction. The movable abutting surface 420a is connected between the first surface region 332 and the third surface region 410. The movable abutting surface 420b is connected between the second surface region 334 and the third surface region 410. In addition, the auxiliary tool 102 includes two auxiliary abutting surfaces 102a, 102b. When the healing abutment 200 is engaged by the auxiliary tool 102, the two auxiliary abutting surfaces 102a, 102b are connected to the two corresponding movable abutting surfaces 420a, 420b, respectively. The auxiliary tool 102 can be rotated by the physician in the X-Y plane, thereby rotating the healing abutment 200. The auxiliary tool 102 of FIG. 8B has a single-convex structure, and the auxiliary tool 102 of FIG. 5 has a double-convex structure. No matter what structure of the auxiliary tool 102, the positioning structure 400 of the healing abutment 200 cooperated with the auxiliary tool 102 can prevent the healing abutment 200 from rotating relative to the implant 104 when the connecting member 500 is rotated, thereby increasing the stability and convenience of installing or removing the healing abutment 200.

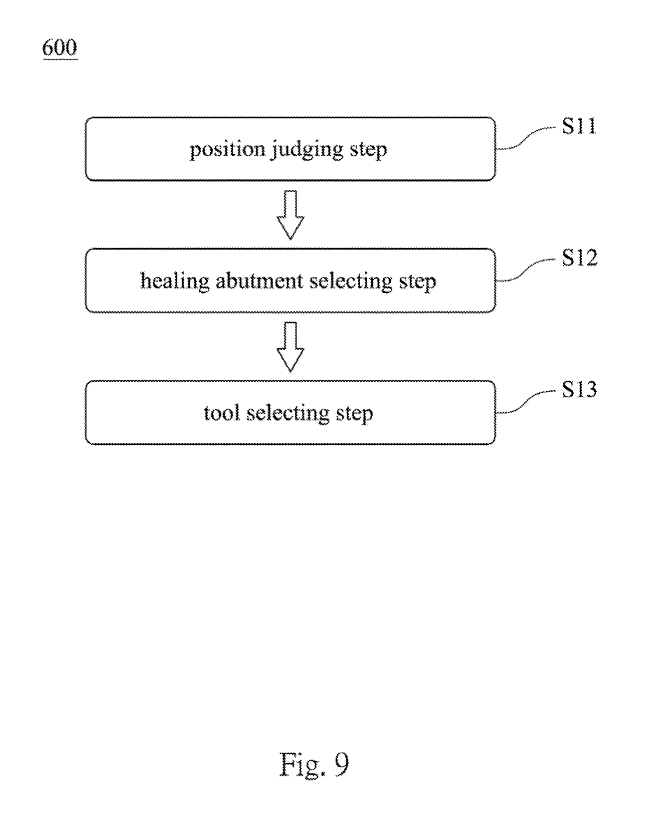

FIG. 9 shows a flow chart of a selecting method 600 of a healing abutment 200 according to one embodiment of the present disclosure. The healing abutment 200 is manufactured and selected at the outside of the body. The selecting method 600 of the healing abutment 200 can be performed by a dental computer system or other judging devices. The selecting method 600 of the healing abutment 200 includes a position judging step S11, a healing abutment selecting step S12 and a tool selecting step S13.

The position judging step S11 is for judging a teeth position corresponding to an implant 104. The teeth position is corresponding to one of the central incisor P1, the lateral incisor P2, the canine P3, the first premolar P4, the second premolar P5, the first molar P6, the second molar P7 and the third molar P8. The human teeth are disposed symmetrically relative to a central plane of the mouth, thus easily inferring the correct teeth positions of the healing abutment 200.

The healing abutment selecting step S12 is for selecting the healing abutment 200 including a healing surrounding surface 320 and a positioning structure 400. The healing surrounding surface 320 is formed in a non-conical shape, and the healing abutment 200 is corresponding to the teeth position. In detail, when the teeth position is corresponding to one of the central incisor P1, the lateral incisor P2 and the canine P3 in the position judging step S11, the healing abutment 200 having the healing surrounding surface 320 formed in the triangular cone shape is selected in the healing abutment selecting step S12. When the teeth position is corresponding to one of the first premolar P4 or the second premolar P5 in the position judging step S11, the healing abutment 200 having the healing surrounding surface 320 formed in an elliptical cone shape is selected in the healing abutment selecting step S12. When the teeth position is corresponding to one of the first molar P6, the second molar P7 and the third molar P8 in the position judging step S11, the healing abutment 200 having the healing surrounding surface 320 formed in a quadrangular cone shape is selected in the healing abutment selecting step S12.

The tool selecting step S13 is for selecting an auxiliary tool 102 corresponding to the positioning structure 400 of the healing abutment 200. The auxiliary tool 102 is a wrench formed into a specific shape. When the connecting member 500 is rotated, the positioning structure 400 of the healing abutment 200 cooperated with the auxiliary tool 102 can prevent the healing abutment 200 from rotating relative to the implant 104, thus increasing the stability and convenience of installing or removing the healing abutment 200. The healing abutment 200 is manufactured and selected at the outside of the body. Accordingly, the selecting method 600 of the present disclosure can be utilized for selecting the suitable healing abutment 200 and the corresponding auxiliary tool 102 according to the teeth positions by the dental computer system, thereby meeting the requirements of a variety of teeth shapes and teeth positions in the dental implant surgery procedure.

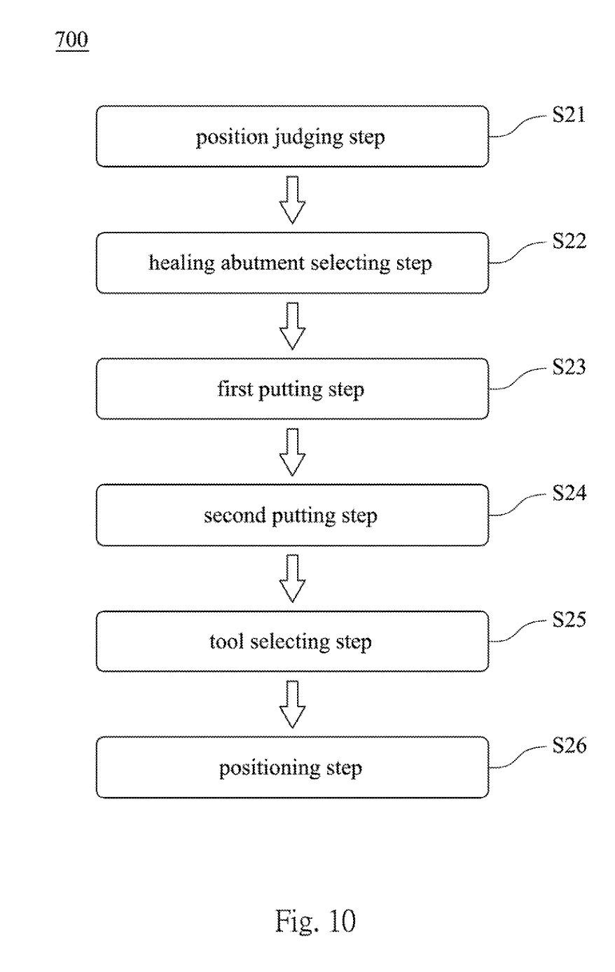

FIG. 10 shows a flow chart of an operating method 700 applied in a healing abutment assembly 100 according to one embodiment of the present disclosure. The operating method 700 includes a position judging step S21, a healing abutment selecting step S22, a first putting step S23, a second putting step S24, a tool selecting step S25 and a positioning step S26.

In FIG. 10, the detail of the position judging step S21, the healing abutment selecting step S22 and the tool selecting step S25 is the same as the position judging step S11, the healing abutment selecting step S12 and the tool selecting step S13 of FIG. 9, respectively, and will not be described again herein. In FIG. 10, the operating method 700 applied in a healing abutment assembly 100 further includes the first putting step S23, the second putting step S24 and the positioning step S26. The first putting step S23 is for putting the healing abutment 200 on the implant 104 and disposing the accommodating space 310 of the healing abutment 200 corresponding to the threaded hole 1042 of the implant 104. The second putting step S24 is for putting the connecting member 500 into the accommodating space 310 and the threaded hole 1042. The positioning step S26 is for rotating the connecting member 500 by the auxiliary tool 102 to screw the threaded portion 510 of the connecting member 500 into the threaded hole 1042, thus tightly positioning the abutting portion 520 of the connecting member 500 in the healing abutment 200. Therefore, when the connecting member 500 is rotated, the auxiliary tool 102 is configured to position the positioning structure 400 of the healing abutment 200 and prevent the healing abutment 200 from rotating relative to the implant 104 so as to increase the stability and convenience of installing or removing the healing abutment 200.

According to the aforementioned embodiments and examples, the advantages of the present disclosure are described as follows.

1. The installation of the specific healing abutments of the present disclosure on the different teeth positions can be successfully performed for gums healing, crowns installation and fitting teeth shapes.

2. The healing abutment assembly, the healing abutment and the selecting method thereof of the present disclosure can provide the healing abutment having a flesh color or a white color. The color of the healing abutment is similar with the surrounding gums or adjacent teeth thereof, thereby pleasing to the eye of an observer and allowing a physician to quickly identify the status of other teeth.

3. The healing abutment of the present disclosure is made of plastic material and has the healing surrounding surface formed in a non-conical shape, thereby greatly reducing the gums damage during a removing procedure of the healing abutment and being a great help for patients.

4. The structure of the present disclosure can effectively prevent the healing surrounding surface from rotating relative to the gums under condition of the healing abutment having the positioning structure and the healing surrounding surface formed in the non-conical shape, thus increasing the safety, stability and convenience of installing or removing the healing abutment.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A healing abutment for disposing on an implant by an auxiliary tool, the healing abutment comprising:
a body comprising an accommodating space, a healing surrounding surface, a top surface and a bottom surface, wherein the bottom surface is connected to the implant, the healing surrounding surface is connected between the top surface and the bottom surface, the accommodating space is communicated with the top surface and the bottom surface, and the healing surrounding surface is formed in a non-conical shape; and
a positioning structure disposed on the top surface and removably connected to the auxiliary tool.

2. The healing abutment of claim 1, wherein the healing surrounding surface is formed in a triangular cone shape corresponding to a teeth position of a central incisor, a lateral incisor or a canine, the healing surrounding surface is formed in an elliptical cone shape corresponding to the teeth position of a first premolar or a second premolar, or the healing surrounding surface is formed in a quadrangular cone shape corresponding to the teeth position of a first molar, a second molar or a third molar.

3. The healing abutment of claim 1, wherein an extending direction of the accommodating space is parallel to a Z-axis direction, the top surface and the bottom surface are parallel to an X-Y plane, an outline area of the top surface is greater than an outline area of the bottom surface, and there is an angle between an extending direction of the healing surrounding surface and the Z-axis direction.

4. The healing abutment of claim 1, wherein the accommodating space has a first space and a second space, the first space is communicated with the second space, the first space has a cylindrical shape and a first inner diameter, the second space has the cylindrical shape and a second inner diameter, and the first inner diameter is greater than the second inner diameter.

5. The healing abutment of claim 1, wherein,
the top surface comprises a first surface region and a second surface region, the first surface region is symmetric with the second surface region along an X-axis direction; and
the positioning structure comprises a third surface region located between the first surface region and the second surface region, there is a first height difference between the third surface region and the first surface region, there is a second height difference between the third surface region and the second surface region, and the first height difference is equal to the second height difference.

6. The healing abutment of claim 5, wherein the positioning structure further comprises:
at least one movable abutting surface connected between the first surface region and the third surface region, and the movable abutting surface parallel to a Z-axis direction.

7. The healing abutment of claim 1, wherein the body and the positioning structure are both made of plastic material and integrally connected with each other.

8. A healing abutment assembly for disposing on an implant by an auxiliary tool, the healing abutment assembly comprising:
a healing abutment, comprising:
a body comprising an accommodating space, a healing surrounding surface, a top surface and a bottom surface, wherein the bottom surface is connected to the implant, the healing surrounding surface is connected between the top surface and the bottom surface, the accommodating space is communicated with the top surface and the bottom surface, an outline of the top surface is formed in a non-circular shape, and the healing surrounding surface is formed in a non-conical shape; and
a positioning structure disposed on the top surface and removably connected to the auxiliary tool; and
a connecting member removably connected to the body and the implant, wherein the connecting member is passed through the body and disposed in the implant so as to fixedly connect the body to the implant.

9. The healing abutment assembly of claim 8, wherein the healing surrounding surface is formed in a triangular cone shape corresponding to a teeth position of a central incisor, a lateral incisor or a canine, the healing surrounding surface is formed in an elliptical cone shape corresponding to the teeth position of a first premolar or a second premolar, or the healing surrounding surface is formed in an quadrangular cone shape corresponding to the teeth position of a first molar, a second molar or a third molar.

10. The healing abutment assembly of claim 8, wherein the connecting member comprises a threaded portion, the implant has a threaded hole and an end surface, the threaded portion is disposed through the accommodating space and is screwed into the threaded hole of the implant so as to tightly connect the end surface to the bottom surface of the body.

11. The healing abutment assembly of claim 8, wherein the accommodating space has a first space and a second space, the first space is communicated with the second space, the first space has a cylindrical shape and a first inner diameter, the second space has the cylindrical shape and a second inner diameter, and the first inner diameter is greater than the second inner diameter.

12. The healing abutment assembly of claim 11, wherein the connecting member comprises:
an abutting portion having a first diameter and corresponding to the first space, and the first diameter smaller than the first inner diameter; and
a connecting portion connected to the abutting portion, wherein the connecting portion has a second diameter and is corresponding to the second space, and the second inner diameter is greater than or equal to the second diameter and smaller than the first diameter.

13. The healing abutment assembly of claim 8, wherein an extending direction of the accommodating space is parallel to a Z-axis direction, the top surface and the bottom surface are parallel to an X-Y plane, an outline area of the top surface is greater than an outline area of the bottom surface, and there is an angle between an extending direction of the healing surrounding surface and the Z-axis direction.

14. The healing abutment assembly of claim 8, wherein,
the top surface comprises a first surface region and a second surface region, the first surface region is symmetric with the second surface region along an X-axis direction; and
the positioning structure comprises a third surface region located between the first surface region and the second surface region, there is a first height difference between the third surface region and the first surface region, there is a second height difference between the third surface region and the second surface region, and the first height difference is equal to the second height difference.

15. The healing abutment assembly of claim 14, wherein the positioning structure further comprises:
at least one movable abutting surface connected between the first surface region and the third surface region, and the movable abutting surface parallel to a Z-axis direction.

16. The healing abutment assembly of claim 8, wherein the body and the positioning structure are both made of plastic material and integrally connected with each other.

17. A selecting method of a healing abutment, comprising:
providing a position judging step, wherein the position judging step is for judging a teeth position corresponding to an implant; and
providing a healing abutment selecting step, wherein the healing abutment selecting step is for selecting the healing abutment comprising a healing surrounding surface and a positioning structure, the healing surrounding surface is formed in a non-conical shape, and the healing abutment is corresponding to the teeth position.

18. The selecting method of the healing abutment of claim 17, wherein,
the position judging step is for judging the teeth position corresponding to one of a central incisor, a lateral incisor or a canine, a first premolar, a second premolar, a first molar, a second molar and a third molar;
when the teeth position is corresponding to one of the central incisor, the lateral incisor and the canine in the position judging step, the healing abutment having the healing surrounding surface formed in a triangular cone shape is selected in the healing abutment selecting step;
when the teeth position is corresponding to one of the first premolar or the second premolar in the position judging step, the healing abutment having the healing surrounding surface formed in an elliptical cone shape is selected in the healing abutment selecting step; and
when the teeth position is corresponding to one of the first molar, the second molar and the third molar in the position judging step, the healing abutment having the healing surrounding surface formed in a quadrangular cone shape is selected in the healing abutment selecting step.

19. The selecting method of the healing abutment of claim 18, further comprising:
providing a tool selecting step, wherein the tool selecting step is for selecting an auxiliary tool corresponding to the positioning structure of the healing abutment.
